(19) United States
(12) Patent Application Publication
(10) Pub. No.: US 2014/0237774 A1
(43) Pub. Date: Aug. 28, 2014

(54) CLIP FOR TENSIONING A CABLE

(71) Applicant: Joseph Kline, Coronado, CA (US)

(72) Inventor: Joseph Kline, Coronado, CA (US)

(73) Assignee: Joseph Kline, Coronado, CA (US)

(21) Appl. No.: 13/773,885

(22) Filed: Feb. 22, 2013

(51) Int. Cl. F16G 11/04

(52) U.S. Cl. CPC F16G 11/046
USPC 24/129 R

(57) ABSTRACT

A clip for removably attaching a one or more cables with a support is provided. The clip includes a base surface and a top surface attached on said base surface, one or more indentations on the top surface and cord. The top surface has a Up protruding to form a channel. The one or more indentations on the top surface through the base surface allow attachment means to attach the base surface on the subject. The cord is kept on a first indent of the base surface and further is pulled around one or more cables and hooked on the lip through the channel.

### BACKGROUND OF THE INVENTION

1. Field of the Invention

The present invention relates to a clip for securing onto a subject and tensioning a one or more cables.

2. Description of Related Art

Various securing devices are known in the art. Most of the devices are used with various fixed supports such as pole to secure animals at the fixed support. Further, such devices may be used for securing boat on dockyards with a cable. These devices generally involve a lot of effort for tying the knot for securing the subject onto the support.

In an effort to eliminate or reduce the need for skilled tying and untying of knots, several devices have been proposed in the past. For example. U.S. Pat. No. 3,540,083 discloses a mooring cable with a throat block attached on the cable. The end of the mooring cable can be wrapped around a mooring post and locked into the throat block, forming a loop around the mooring post. The end of the cable can be quickly released from the throat block by pulling on a pin.

The disadvantages with these devices are that they either require the use of a complicated device or cannot be used with different mooring lines. Further, these devices generally require tying of cable as knot at the end of the support. Therefore, there is a need of a device for a clip device to allow securing of the subject through cable onto a support. Furthermore, the clip device should be portable and easy in use.

### SUMMARY

In accordance with the teachings of the present invention, a clip for tensioning a cable is provided.

An object of the present invention is to provide a clip with top surface, bottom surface, one or more indentations and a cord.

Another object of the present invention is to provide a clip to allow removably attaching a one or more cables with a support. Further, a support may be a boat.

Another object of the present invention is to provide a clip for allowing securing a subject such as animal with a support such as pole.

### BRIEF DESCRIPTION OF DRAWINGS

FIG. 1 illustrates an exploded view of the clip in accordance with an embodiment of the present invention;

FIG. 2 illustrates a bottom view of the cord secured in the first indent of the base surface, in accordance with a preferred embodiment of the present invention;

FIG. 3 illustrates a perspective view of the top surface with the cord, in accordance with a preferred embodiment of the present invention; and

FIG. 4 illustrates a perspective view of the cord pulled around the cable and hooked on the lip, in accordance with an embodiment of the present invention.

### DETAILED DESCRIPTION OF THE DRAWINGS

While this technology is illustrated and described in a preferred embodiment, the clip may be produced in many different configurations, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

Reference will now be made in detail to several embodiments of the invention which are illustrated in the accompanying drawings. Wherever feasible and convenient, the same reference numerals are used in the figures and the description to refer to the same or like parts. The drawings are in a simplified form and not to precise scale. For purposes of convenience and clarity only, directional terms, such as top, bottom, left, right, up, down, over, above, below, beneath, rear, and front may be used with respect to the accompanying drawings. These and similar directional terms should not be strictly construed to limit the scope of the invention. In addition, words such as attached, affixed, coupled, connected and similar terms with their inflectional morphemes are used interchangeably, unless the difference is noted or made otherwise clear from the context. These words and expressions do not necessarily signify direct connections, but include connections through mediate components and devices.

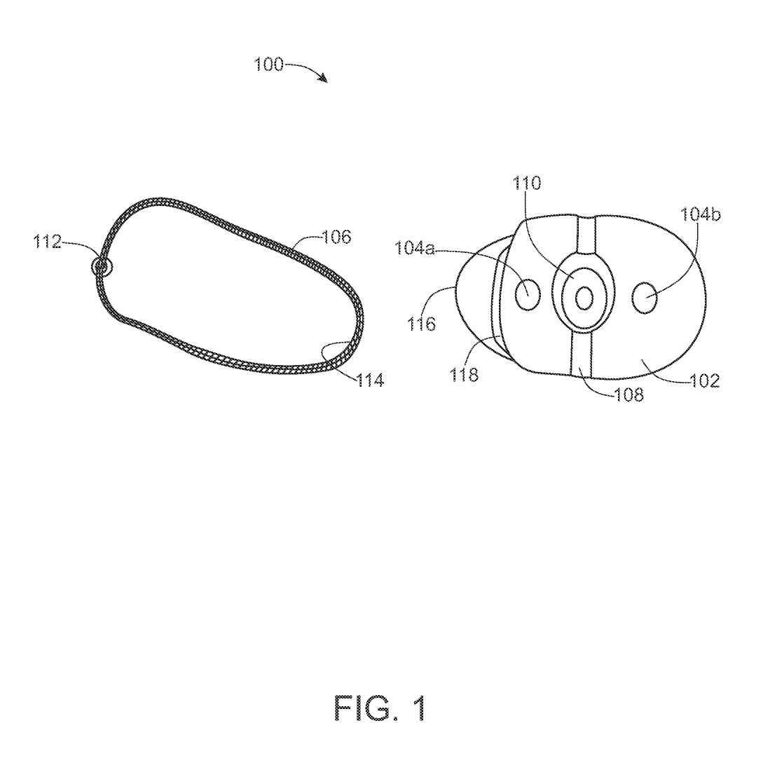

FIG. 1 illustrates an exploded view of clip 100. The clip 100 removably attaches a one or more cables (not shown in FIG. 1) with a support (not shown in FIG. 1). The clip 100 includes a base surface 102, a top surface (not shown in FIG. 1) attached on the base surface 102, one or more indentations 104 such as 104a and 104b and a cord 106. The base surface 102 includes a passage 108 and a first indent 110 placed between said passage 108. In a preferred embodiment, the passage 108 passes from the center of the base surface 102 in horizontal direction.

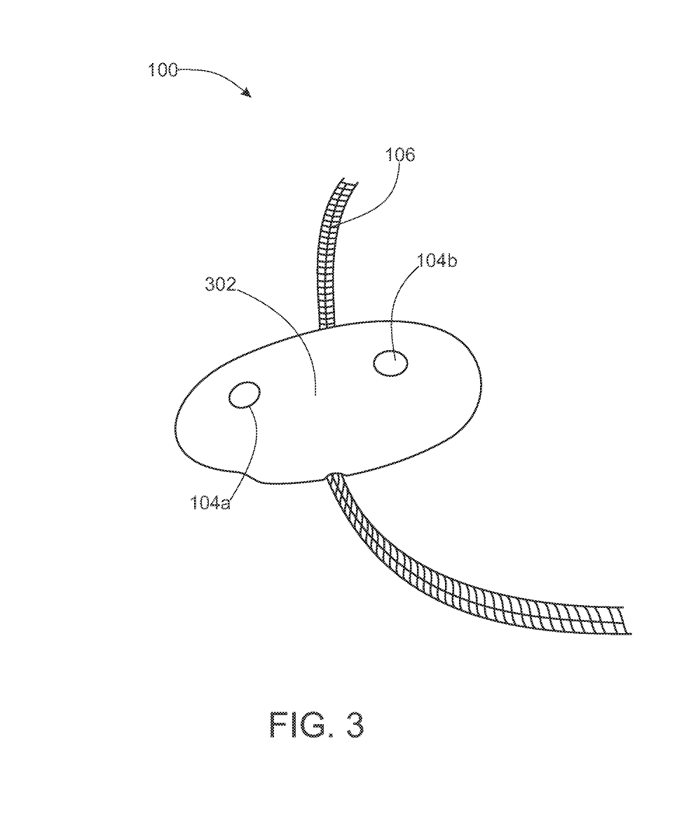

In a preferred embodiment of the present invention, the top surface is having a front end and a rear end. The front end is having a lip 116 protruding to form a channel 118. The top surface is explained in detailed in conjunction in with FIG. 3 of the present invention. The one or more indentations 104 are provided on the top surface (not shown in FIG. 1) through the base surface 102. The one or more indentations 104 to allow securing of base surface 102 with the support. In an embodiment of the present invention the support is boat or fixed pole.

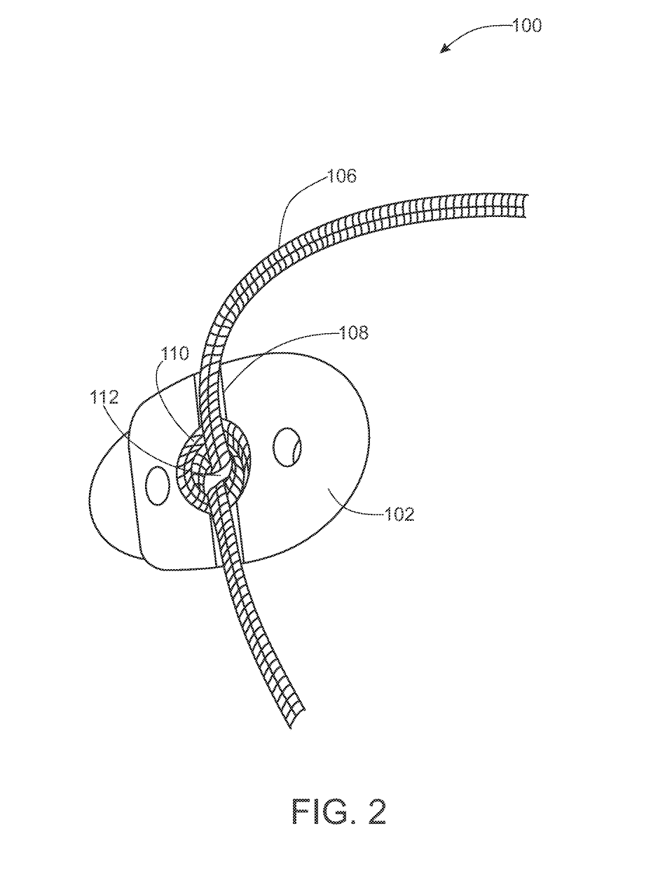

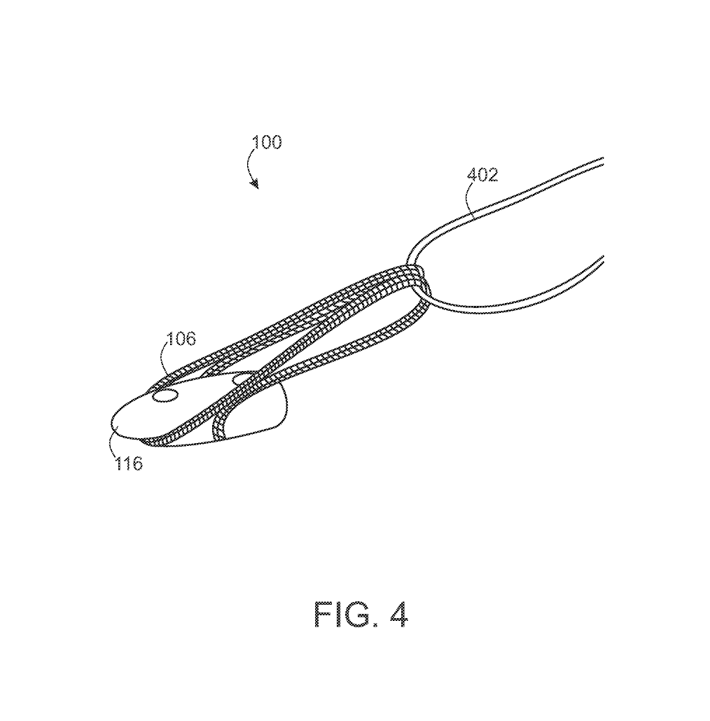

The cord 106 includes a knot end 112 and a loop end 114. The cord 106 is made to pass through the passage 108. The loop end 114 is pulled to move around the one or more cables (not shown in FIG. 1) and removably hooked to the lip 116 through the channel 118. The knot end 112 is explained in detailed in conjunction with FIG. 2 of the present invention. The mechanism of pulling the loop end 114 to move around the one or more cables is explained in detailed in conjunction with FIG. 4 of the present invention.

FIG. 2 illustrates a bottom view of the cord 106 secured in the first indent 110 of the base surface 102. The knot end 112 is secured on to the first indent 110. In a preferred embodiment of the present invention, the first end 110 is of circular shape. The knot end 112 being held in the first indent 110 may also serves the purpose of not allowing the cord 106 to move and be pulled out more by the one or more cables (not shown in FIG. 2). In another preferred embodiment, the knot end 112 may be secured through adhesive or other attachment means. Further, the cord 106 is made to pass through the passage 108. The passage 108 provides a grip to the cord 106 for free movement.

FIG. 3 illustrates a perspective view of the top surface 302 with the cord 106. The top surface 302 is of flat shape from the center and curved from the edges. Further, the one or more indentations 104a and 104b on the top surface 302 passes through the base surface (not shown in FIG. 3) and allow securing of the base surface (not shown in FIG. 3) with the support.

FIG. 4 illustrates a perspective view of the cord 106 pulled around the cable 402 and hooked on the lip 116 through the channel (not shown in FIG. 4), in accordance with an embodiment of the present invention. The weight of the cable 402 causes tension and the clip 100 keeps the support (not shown in Figures) to hold its place. In another embodiment of the present invention, the weight of the support with the clip 100 maintains the position of the subject. Further in order to unhook the cord 106 may be lift over the lip 116 and thus the cable 402 is released. Examples of subject include but not limited to an animal and bag etc.

Further, it would be readily apparent to those skilled in the art that the clip may also be used to hold multiple cables. Also, it is to be noted that novelty of the system is providing facility of removing cable easily through the lip and channel in the clip. Furthermore, the clip may also be used to maintain the position of the boat in the sea/ocean by attaching the clip with cables to a wall/floor.

It will be readily apparent to those skilled in the art that the base surface, the top surface, the one or more indentations, the cord, the first indent, the passage, the lip, the channel, the knot end and the loop end may be produced in different sizes, shape and color, without deviating from the scope of the present invention.

The foregoing discussion discloses and describes merely exemplary embodiments of the technology described herein. One skilled in the art will readily recognize from such discussion and from the accompanying drawings that various changes, modifications and variations can be made therein without departing from the spirit and scope of the invention.

1. A clip for removably attaching one or more cables with a support, said clip comprising:
a base surface having a passage and a first indent placed between said passage;
a top surface attached on said base surface, said top surface having a front end and a rear end, said front end having a lip protruding to form a channel;
one or more indentations on said top surface passing through said base surface, said one more indentations to attach the base surface with said support; and
a cord having a knot end and a loop end, said cord passes through said passage, said knot end secured on said first indent, said loop end made to pull around said one or more cables and further said loop end removably hooked to said lip through said channel.

2. The clip according to claim 1 further comprises one or more attachment means for securing said base surface with said support through said one or more indentations.

3. The clip according to claim 1 wherein said base surface is a flat shape.

4. The clip according to claim 1 wherein said top surface is flat shape from the center and curved from the edges.

5. The clip according to claim 1 wherein said support is a boat.

6. The clip according to claim 1 wherein said support is a pole.

7. The clip according to claim 1 wherein said one or more cables is attached to a subject.

8. The clip according to claim 7 wherein said subject is an animal.

9. The clip according to claim 7 wherein said subject is a bag.
